(19) United States
(12) Patent Application Publication
(10) Pub. No.: US 2021/0009268 A1
(43) Pub. Date: Jan. 14, 2021

(54) METHOD FOR MANAGING LOAD APPARATUS, TERMINAL DEVICE, AND MOBILE PLATFORM SYSTEM

(71) Applicant: SZ DJI TECHNOLOGY CO., LTD., Shenzhen (CN)

(72) Inventors: Yong YANG, Shenzhen (CN); Hanping CHEN, Shenzhen (CN); Gen TIAN, Shenzhen (CN)

(21) Appl. No.: 17/028,438

(22) Filed: Sep. 22, 2020

Related U.S. Application Data
(63) Continuation of application No. PCT/CN2018/080172, filed on Mar. 23, 2018.

(51) Int. Cl. B64C 39/02; H04W 4/40

(52) U.S. Cl. CPC B64C 39/024; B64C 2201/146; B64C 2201/127; H04W 4/40

(57) ABSTRACT

A method for managing a load apparatus carried by a mobile platform, including: in response to an application of the load apparatus corresponding to the mobile platform being started, obtaining control information stored in the load apparatus; and configuring a display interface of the application and displaying function controls, according to the control information, to manage the load apparatus through the function controls.

### CROSS-REFERENCE TO RELATED APPLICATION

This application is a continuation of International Application No. PCT/CN2018/080172, filed on Mar. 23, 2018, the entire content of which is incorporated herein by reference.

### TECHNICAL FIELD

The disclosure relates to the technical field of a mobile platform, in particular relates to a method for managing a load apparatus, a terminal device, and a mobile platform system.

### BACKGROUND

Unmanned aerial vehicles (UAVs) are widely used to complete various tasks. The UAV may carry a load apparatus, which can be used in different application scenarios.

The development of the load product mainly includes two aspects, namely, the development of the load apparatus and the development of the load application (APP) program. The load application is mainly used to control the load apparatus and display related information of the load apparatus. The UAV may also have a corresponding UAV control application, which is used to control the UAV and display the relevant information of the UAV.

When the UAV and load apparatus are in use, two terminal devices are required to respectively operate the UAV application and the load application. As a result, the operator needs to observe the information in the two devices at the same time during the operation. This is inconvenient for the user, and provides poor user experience.

### SUMMARY

One aspect of the present disclosure provides a method for managing a load apparatus carried by a mobile platform. The method includes: in response to an application of the load apparatus corresponding to the mobile platform being started, obtaining control information stored in the load apparatus; and configuring a display interface of the application and displaying function controls, according to the control information, to manage the load apparatus through the function controls.

Another aspect of the present disclosure provides a mobile platform. The mobile platform includes a load apparatus management application for managing a load apparatus. When executed by one or more processors, the load apparatus management application implements a load apparatus management method. The method includes: in response to an application of the load apparatus corresponding to the mobile platform being started, obtaining control information stored in the load apparatus; and configuring a display interface of the application and displaying function controls, according to the control information, to manage the load apparatus through the function controls.

### BRIEF DESCRIPTION OF THE DRAWINGS

In order to more clearly explain the embodiments of the present disclosure or the technical solutions in the existing technology, the following will briefly introduce the drawings used in the description of the embodiments or the existing technology. Apparently, the drawings in the following description are some embodiments of the present disclosure. For those of ordinary skill in the art, other drawings can be obtained based on these drawings without making any creative efforts.

FIG. 1 is a structural diagram of a mobile platform system according to an embodiment of the present disclosure;

FIG. 2 is a schematic diagram of communication within the mobile platform system according to an embodiment of the present disclosure;

FIG. 3 is another schematic diagram of the communication within the mobile platform system according to an embodiment of the present disclosure;

FIG. 4 is a flowchart of a method for managing a load apparatus according to an embodiment of the present disclosure;

FIG. 5 is a schematic diagram of a display interface of an application according to an embodiment of the present disclosure;

FIG. 6 is another schematic diagram of the display interface of the application according to an embodiment of the present disclosure; and

FIG. 7 is a structural diagram of a terminal device according to an embodiment of the present disclosure.

### DETAILED DESCRIPTION OF THE EMBODIMENTS

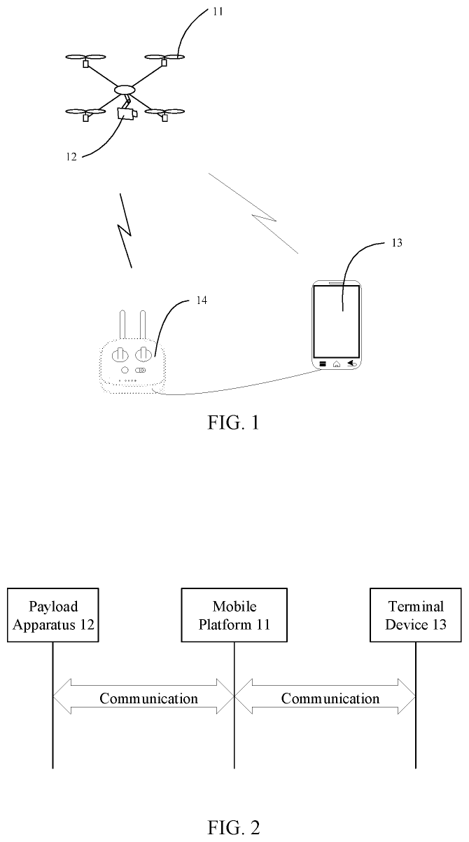

The disclosure provides a method for managing a load apparatus, a terminal device, and a mobile platform system. FIG. 1 is a structural diagram of a mobile platform system according to an embodiment of the present disclosure. As shown in FIG. 1, the mobile platform system may include: a mobile platform 11, a load apparatus 12 and a terminal device 13. The load apparatus 12 may be carried by the mobile platform 11. An application corresponding to the mobile platform 11 may be installed in the terminal device 13, to control the mobile platform 11 and display related information of the mobile platform 11. In some embodiments, the system of the mobile platform 11 may further include a remote control device 14, and the user can control the mobile platform 11 through the remote control device 14. It should be noted that the present disclosure does not limit the types of the mobile platform 11, the load apparatus 12, the terminal device 13, and the remote control device 14. Alternatively, the mobile platform 11 may be a UAV, an unmanned vehicle, etc. The UAV may be a rotorcraft, for example, a multi-rotor aircraft propelled by multiple propulsion devices through air. The load apparatus 12 may be a camera device, an imaging device, etc. The terminal device 13 may be a smart phone, a tablet computer, etc. The remote control device 14 may be a rocker remote control, or the like.

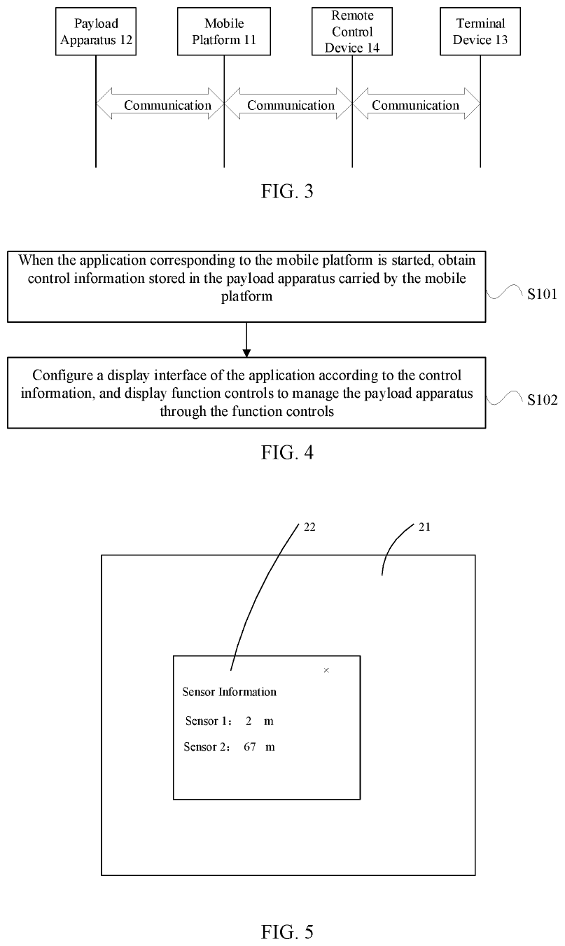

In some embodiments, FIG. 2 is a schematic diagram of communication within the mobile platform system according to an embodiment of the present disclosure. As shown in FIGS. 1 and 2, the mobile platform 11 may communicate with the load apparatus 12 based on a communication protocol in a wireless or wired manner. The communication protocol may be a communication protocol within the mobile platform 11, or other existing communication protocols, or a custom communication protocol between the mobile platform 11 and the load apparatus 12. The wireless communication can be performed between the mobile platform 11 and the terminal device 13 through a wireless network. The wireless network may be a wireless self-organizing network, such as a wireless local area network (e.g., Wi-Fi). The wireless network may also be a public wireless communication network. In some embodiments, FIG. 3 is another schematic diagram of the communication within the mobile platform system according to an embodiment of the present disclosure. As shown in FIGS. 1 and 3, a communication between the mobile platform 11 and the terminal device 13 can also be achieved through the remote control device 14. In some embodiments, the remote control device 14 and the terminal device 13 may be wirelessly connected, that is, communicated through a wireless network. In some embodiments, the remote control device 14 and the terminal device 13 may be connected by wire, for example, through a universal serial bus (USB) interface. The wireless communication can be performed between the mobile platform 11 and the remote control device 14 through the wireless network.

In each embodiment of the present disclosure, the load apparatus is taken as the imaging device, as an example for description.

The technical solutions in the embodiments of the present disclosure will be described clearly and completely in conjunction with the drawings in the embodiments of the present disclosure. Apparently, the described embodiments are some of the embodiments of the present disclosure, but not all of the embodiments. Based on the embodiments of the present disclosure, all other embodiments obtained by a person of ordinary skill in the art without making creative efforts shall fall within the scope of the disclosure.

FIG. 4 is a flowchart of a method for managing the load apparatus according to an embodiment of the present disclosure. In the method for managing the load apparatus provided in this embodiment, the performing body may be a terminal device. As shown in FIG. 4, the method for managing the load apparatus provided in this embodiment may include:

S101: When the application corresponding to the mobile platform is started, obtaining control information stored in the load apparatus carried by the mobile platform.

Specifically, the control information may be pre-stored in the load apparatus. The control information can be different for different load apparatuses. Developers can customize the control information according to the type, function and usage requirements of the load apparatus. In some embodiments, the control information may be implemented by an XML, file, java code, or other forms of programming language, which is not specifically limited by this embodiment.

The control information may include a control name, a control identifier, a control type, and a control style.

The control identifier can uniquely distinguish different controls. The control type may include switches, buttons, progress bars, multiple choice lists, and value input boxes. The control style may be configured to control the display mode of the control, e.g., floating display, pop-up display, etc.

This embodiment does not limit the application scenario started by the application corresponding to the mobile platform. In one application scenario, the application may be initially started. In another application scenario, the application may be restarted after an interruption of operation.

In some embodiments, in one implementation, in S101, obtaining control information stored in the load apparatus carried by the mobile platform may include: sending a control acquisition request to the mobile platform, the control acquisition request being configured to trigger the mobile platform to obtain the control information stored in the load apparatus; and receiving the control information sent by the mobile platform.

Specifically, referring to FIGS. 1 and 2., the terminal device sends a control acquisition request to the mobile platform. After receiving the control acquisition request sent by the terminal device, the mobile platform sends a message to the load apparatus to obtain the control information stored in the load apparatus. After receiving the message sent by the mobile platform, the load apparatus sends the control information to the mobile platform. The mobile platform then sends the control information to the terminal device.

In some embodiments, in another implementation manner, in S101, obtaining the control information stored in the load apparatus carried by the mobile platform may include: sending the control acquisition request to the mobile platform through a remote control device, the control acquisition request being configured to trigger the mobile platform to acquire the control information stored in the load apparatus; and receiving the control information sent by the mobile platform through the remote control device.

Specifically, referring to FIGS. 1 and 3, the terminal device sends the control acquisition request to the remote control device to obtain control information stored in the load apparatus. The remote control device sends the control acquisition request to the mobile platform. After receiving the control acquisition request sent by the remote control device, the mobile platform sends a message to the load apparatus to obtain the control information stored in the load apparatus. After receiving the message sent by the mobile platform, the load apparatus sends the control information to the mobile platform. The mobile platform then sends the control information to the terminal device through the remote control device.

S102: Configuring a display interface of the application according to the control information, and displaying function controls to manage the load apparatus through the function controls.

Specifically, after the application corresponding to the mobile platform is started, the display interface of the application may be configured to manage the mobile platform through the application. In this embodiment, since the control information stored in the load apparatus can be acquired, the display interface of the application may be configured according to the control information. In the display interface of the application, in addition to displaying the functions of the mobile platform, function controls related to the load apparatus may also be displayed. Therefore, the user can manage the load apparatus and the mobile platform at the same time through the application corresponding to the mobile platform.

Accordingly, according to the method for managing the load apparatus provided in this embodiment, the function controls related to the load apparatus can be displayed in the application corresponding to the mobile platform by obtaining the control information stored in the load apparatus, and integrating the load apparatus function into the application corresponding to the mobile device. As such, the management of the mobile platform and the load apparatus can be achieved through one application and one terminal device, which reduces the number of the terminal devices, applications, and display interfaces, and the degree of integration can be better, which facilitates the management of the mobile platform and the load apparatus by the user and improves the user experience. Moreover, there is no need to specially develop the load apparatus application, thereby saving development manpower, time and workload, and reducing investment to the development. In addition, the control information can be customized, which improves the flexibility of managing the load apparatus.

In some embodiments, in S102, managing the load apparatus through the function controls may include: displaying data of the load apparatus through the function controls.

Specifically, during the normal use of the load apparatus, the relevant data of the load apparatus may need to be displayed so that the user can control the load apparatus according to the data. The type of the load apparatuses may be different, and the data of the load apparatuses may be different, which is not limited by this embodiment. For example, the data of the load apparatus may include data of sensors disposed on the load apparatus. The following is a specific example.

FIG. 5 is a schematic diagram of a display interface of an application according to an embodiment of the present disclosure. As shown in FIG. 5, the display interface 21 of the application includes a load apparatus data display window 22. The relevant data of the sensors disposed on the load apparatus can be displayed on the load apparatus data display window 22.

In some embodiments, the method for managing the load apparatus provided in this embodiment may further include: receiving the data of the load apparatus sent by the mobile device, the data of the load apparatus being sent to the mobile device by the load apparatus; and displaying the data of the load apparatus in the function controls.

In this implementation, the terminal device receives the data sent by the load apparatus. Specifically, the load apparatus first sends the data of the load apparatus to the mobile device. The mobile device then sends the data of the load apparatus to the terminal device. Accordingly, the terminal device can display the data of the load apparatus in the function controls.

In some embodiments, if the wireless communication can be performed between the terminal device and the mobile device, receiving the data of the load apparatus sent by the mobile device may include: receiving the data of the load apparatus sent by the mobile device through the wireless network.

In some embodiments, if the terminal device and the mobile device can communicate through the remote control device, receiving the data of the load apparatus sent by the mobile device may include: receiving the data of the load apparatus sent by the mobile device through the remote control device.

In some embodiments, in S102, managing the load apparatus through the function controls may include: controlling the load apparatus through the function controls.

Specifically, during normal use of the load apparatus, the load apparatus may need to be controlled. For different load apparatuses, the control operation of the load apparatuses can be different. For example, if the load apparatus is a camera device, the control of the load apparatus may include: start shooting, stop shooting, adjust the volume, take pictures, adjust the shooting mode, and so on. In this embodiment, the load apparatus can be controlled through the function controls related to the load apparatus that is displayed on the display interface of the application. The following is a specific example.

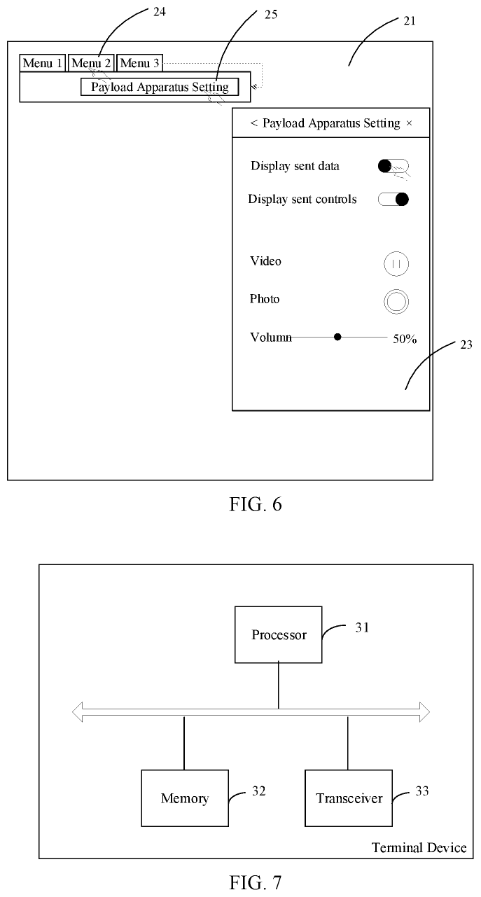

FIG. 6 is another schematic diagram of the display interface of the application provided by an embodiment of the present disclosure. As shown in FIG. 6, the display interface 21 of the application includes a load apparatus setting window 23. The load apparatus setting window 23 may include the following function controls: “video”, “photograph” and “volume”. The type of the function controls “video” and “photograph” is button. The user can operate the buttons to control the camera device to start shooting, stop shooting, take pictures, and so on. The type of the function controls “volume” is progress bar. The user can drag the progress bar to control the camera device to adjust the volume.

In some embodiments, controlling the load apparatus through the function controls may include: obtaining value of the function controls that the user inputs during the operation of the function controls; sending the values of the function controls to the mobile platform to cause the mobile platform to send the value of the function controls to the load apparatus and cause the load apparatus to perform an operation corresponding to the values of the function controls according to the correspondence between the function controls and the operation.

In this implementation, the user can obtain the values of the function controls by operating the function controls. The terminal device sends the values of the function controls to the load apparatus through the mobile platform. Furthermore, the load apparatus can determine the corresponding operation according to the values of the function controls and perform the corresponding operation. The correspondence between the function controls and operations may be pre-stored in the load apparatus.

For example, referring to FIG. 6, the user clicks the button corresponding to “photograph” in the load apparatus setting window 23, and at this time, the value of the function control “photograph” may be 1. The terminal device sends the value to the load apparatus through the mobile platform. The load apparatus determines that the operation corresponding to the value, 1, of the function control “photograph” is to take pictures according to the correspondence between the function control and the operation, and the photographing operation can be performed.

In another example, the user drags the progress bar corresponding to “volume” to middle position in the load apparatus setting window 23. At this time, the value of the function control “volume” can be 50%. The terminal device sends the value to the load apparatus through the mobile platform. The load apparatus determines that the operation corresponding to the value, 50%, of the function control “volume”, is to adjust the volume to 50% of the maximum volume according to the correspondence between the function control and the operation, and the volume adjustment operation can be performed.

In some embodiments, controlling the load apparatus through the function controls may include: obtaining the load operation instruction of the user's operation input to the function controls; and sending the load operation instruction to the mobile platform to cause the mobile platform to send the load operation instruction to the load apparatus and cause the load apparatus to perform the corresponding operation according to the load operation instruction.

In this implementation manner, the user operates the function controls, and the terminal device can determine the user's operation to the load apparatus and obtain the load operation instruction. The terminal device sends the load operation instruction to the load apparatus through the mobile platform. Furthermore, the load apparatus can perform the corresponding operation according to the load operation instruction.

For example, referring to FIG. 6, the user clicks the button corresponding to “photograph” in the load apparatus setting window 23. At this time, the terminal device may generate a load operation instruction, which instructs the load apparatus to take a picture. The terminal device sends the load operation instruction to the load apparatus through the mobile platform. The load apparatus can perform the photographing operation according to the load operation instruction.

In some embodiments, in S102, configuring the display interface of the application according to the control information, and displaying the function controls may include: generating a floating window according to the control information, the floating window including the function controls; and displaying the floating window afloat in the display interface of the application.

In this implementation manner, the display effect of the function controls related to the load apparatus in the display interface of the application is that a floating window can be displayed afloat in the display interface of the application, and at least one function control related to the load apparatus can be displayed in the floating window. The following is an example for illustration.

As shown in FIG. 5, the load apparatus data display window 22 is a floating window, which includes function controls “sensor 1” and “sensor 2”. The value of “sensor 1” is 2 m, and the value of “sensor 2” is 67 m.

It should be noted that, in this embodiment, the number of the function controls included in the floating window is not limited, and can be set as required.

In some embodiments, in S102, configuring the display interface of the application according to the control information and displaying the function controls may include: generating function keys based on the control information; obtaining control display instructions for the user to perform input operation on the function keys; and displaying the function controls in the display interface of the application according to the control display instruction.

In this implementation manner, the display effect of the function controls related to the load apparatus in the display interface of the application is that the function keys can be displayed in the display interface of the application and the user can operate the function keys to display the function controls in the display interface of the application. It should be noted that this embodiment does not limit the implementation manner of the function keys. For example, the function keys may be a menu or a switch. This embodiment does not limit the display manner of the function controls. For example, the function controls may be individually displayed on the display interface of the application, or multiple function controls can be displayed together in the display window. That is, the control window can be displayed in the display interface of the application according to the control display instruction, and the control window includes the function controls. The following is an example for illustration.

Referring to FIGS. 5 and 6, in FIG. 6, the load apparatus setting window 23 includes a function button “display sent data”. The user can operate the switch corresponding to “display sent data” to control whether to display the function controls in the display interface of the application. Assuming that when the switch corresponding to “display sent data” is on, as shown in FIG. 5, the load apparatus data display window 22 can be displayed in the display interface 21 of the application.

In another example, referring to FIG. 6, a menu 24 is displayed in the display interface 21 of the application, including “Menu 1”, “Menu 2”, and “Menu 3”. When the user clicks on the “Menu 2”, a function key “load apparatus setting” 25 can be displayed. The user can click on the “load apparatus setting” 25 to display the load apparatus setting window 23 in the display interface 21 of the application.

Further, the method for managing the load apparatus provided in this embodiment may further include: receiving updated control information sent by the mobile device, the updated control information being sent to the mobile device by the load apparatus; and updating the display interface of the application and configuring the display interface of the application according to the updated control information.

Specifically, when the control information stored in the load apparatus is updated, the load apparatus may send the updated control information to the mobile device. The mobile device then sends the updated control information to the terminal device. After receiving the updated control information sent by the mobile device, the terminal device updates the display interface of the application and configures the display interface of the application according to the updated control information to ensure the correct display of the function controls.

Accordingly, because control information is stored in the load apparatus, the terminal device can display the function controls in the display interface of the application by obtaining the control information. When the function of the load apparatus changes, only the control information needs to be updated. In comparison with the existing technology that requires the development of the load apparatus APP, the development workload can be smaller, the development period can be shorter, and the implementation of the product can be more flexible, and simpler.

This embodiment provides a method for managing the load apparatus. The method includes: when an application corresponding to an mobile platform is started, obtaining control information stored in a load apparatus carried by the mobile platform, and configuring a display interface of the application according to the control information and displaying function controls to manage the load apparatus through the function controls. According to the method for managing the load apparatus provided in this embodiment, the function controls related to the load apparatus corresponding to the mobile platform may be displayed in the application by obtaining the control information stored in the load apparatus, so that the management of the mobile platform and the load apparatus can be implemented by one application, which facilitates the user's management of the mobile platform and load apparatus and improves the user experience.

FIG. 7 is a structural diagram of a terminal device according to an embodiment of the present disclosure. The terminal device provided in this embodiment is configured to execute the method for managing the load apparatus provided in the method embodiment of the present disclosure. As shown in FIG. 7, the terminal device provided in this embodiment may include: a memory 32, a processor 31, and a transceiver 33. The terminal device may also include a display screen.

The memory 32 is configured to store program codes.

The processor 31 calls the program code, and when the program code is executed, it is configured to perform the following operations: when an application corresponding to a mobile platform is started, a transceiver 33 obtains the control information stored in a load apparatus carried by the mobile platform; configure a display interface of the application according to the control information and display function controls to manage the load apparatus through the function controls.

In some embodiments, the processor 31 is specifically configured to display data of the load apparatus through the function controls.

In some embodiments, the transceiver 33 is further configured to receive the data of the load apparatus sent by the mobile device. The data of the load apparatus is sent to the mobile device by the load apparatus.

The processor 31 is further configured to display the data of the load apparatus in the function controls.

In some embodiments, the transceiver 33 is specifically configured to receive the data of the load apparatus sent by the mobile device through a wireless network.

In some embodiments, the transceiver 33 is specifically configured to receive the data of the load apparatus sent by the mobile device through a remote control device.

In some embodiments, the data of the load apparatus includes data of sensors disposed on the load apparatus.

In some embodiments, the processor 31 is specifically configured to control the load apparatus through the function controls.

In some embodiments, the processor 31 is specifically configured to obtain values of the function controls that the user inputs to the function controls.

The values of the function controls are sent to the mobile platform through the transceiver 33, which can cause the mobile platform to send the value of the function controls to the load apparatus and cause the load apparatus to perform an operation corresponding to the value of the function controls according to the correspondence between the function controls and the operation.

In some embodiments, the processor 31 is specifically configured to obtain the load operation instruction of the user's operation input to the function controls.

The load operation instruction can be sent to the mobile platform through the transceiver 33, which can cause the mobile platform to send the load operation instruction to the load apparatus and cause the load apparatus to perform a corresponding operation according to the load operation instruction.

In some embodiments, the processor 31 is specifically configured to: generate a floating window according to the control information, the floating window including the function controls; and display the floating window afloat in the display interface of the application.

In some embodiments, the processor 31 is specifically configured to: generate function keys based on the control information; and obtain control display instructions for the user to perform input operation on the function keys.

The function controls can be displayed in the display interface of the application according to the control display instruction.

In some embodiments, the processor 31 is specifically configured to display a control window in the display interface of the application according to the control display instruction. The control window includes function controls.

In some embodiments, the transceiver 33 is specifically configured to send a control acquisition request to the mobile platform, the control acquisition request being configured to trigger the mobile platform to obtain the control information stored in the load apparatus; and receive the control information sent by the mobile platform.

In some embodiments, the transceiver 33 is further configured to receive updated control information sent by the mobile device. The updated control information is sent to the mobile device by the load apparatus.

The processor 31 is further configured to update the display interface of the application and configure the display interface of the application according to the updated control information.

In some embodiments, the control information includes a control name, a control identifier, a control type, and a control style.

In some embodiments, the type of the controls includes switches, buttons, progress bars, multiple choice lists, and value input boxes.

The terminal device provided by the embodiment of the present disclosure is configured to execute the method for managing the load apparatus provided by the method embodiment of the present disclosure. The technical principle and technical effect of the terminal device is similar, which will not be repeated here.

An embodiment of the present disclosure also provides a mobile platform system, which may include the mobile platform, the load apparatus, and the terminal device provided by the embodiments of the present disclosure.

The load apparatus is carried by the mobile platform.

In some embodiments, the mobile platform system may also include a remote control device.

It should be noted that this embodiment does not limit the types of the mobile platform, the load apparatus, the terminal device, and the remote control device.

The mobile platform system provided by the embodiment of the present disclosure includes the terminal device configured to execute the method for managing the load apparatus provided by the method embodiment of the present disclosure. The technical principle and technical effect is similar, which will not be repeated here.

A person of ordinary skill in the art should understand that all or some of the steps of the foregoing method embodiments may be achieved by a hardware related to the program instruction. The aforementioned program may be stored in a computer-readable storage medium, and when the program is executed, may execute the steps including the foregoing method embodiments. The foregoing storage medium includes various mediums that can store program codes, such as ROM, RAM, magnetic disk, or optical disk.

Finally, it should be noted that the above embodiments are only used to illustrate the technical solutions of the embodiments of the present disclosure, rather than to limit them. Although the embodiments of the present disclosure have been described in detail with reference to the foregoing embodiments, those of ordinary skill in the art should understand that they can still modify the technical solutions described in the foregoing embodiments, or equivalently substitute some or all of the technical features therein; and these modifications or substitutions do not deviate the essence of the corresponding technical solutions from the scope of the technical solution of the embodiments of the present disclosure.

What is claimed is:

1. A method for managing a load apparatus carried by a mobile platform, comprising:
in response to an application of the load apparatus corresponding to the mobile platform being started, obtaining control information stored in the load apparatus; and
configuring a display interface of the application and displaying function controls, according to the control information, to manage the load apparatus through the function controls.

2. The method according to claim 1, further comprising:
displaying data of the load apparatus through the function controls.

3. The method according to claim 2, further comprising:
receiving the data of the load apparatus sent by the mobile device, the data of the load apparatus being sent to the mobile device by the load apparatus; and
displaying the data of the load apparatus in the function controls.

4. The method according to claim 3, wherein receiving the data of the load apparatus sent by the mobile device comprises:
receiving the data of the load apparatus sent by the mobile device through a wireless network.

5. The method of claim 3, wherein receiving the data of the load apparatus sent by the mobile device comprises:
receiving the data of the load apparatus sent by the movable device through a remote control device.

6. The method according to claim 2, wherein the data of the load apparatus comprises:
data received from sensors disposed on the load apparatus.

7. The method according to claim 1, further comprising:
controlling the load apparatus through the function controls.

8. The method according to claim 7, wherein controlling the load apparatus through the function controls comprises:
obtaining values of the function controls inputted by a user; and
sending the values of the function controls to the mobile platform, the mobile platform sending the values of the function controls to the load apparatus and causing the load apparatus to perform an operation corresponding to the values of the function controls.

9. The method according to claim 7, wherein control the load apparatus through the function controls comprises:
obtaining a load operation instruction inputted through the function controls; and
sending the load operation instruction to the mobile platform to cause the mobile platform to send the load operation instruction to the load apparatus and cause the load apparatus to perform a corresponding operation according to the load operation instruction.

10. The method according to claim 1, wherein configuring the display interface of the application and display function controls according to the control information comprises:
generate a floating window according to the control information, the floating window including the function controls; and
displaying the floating window afloat in the display interface of the application.

11. The method according to claim 1, wherein configure the display interface of the application and display function controls according to the control information comprises:
generating function keys according to the control information;
obtaining control display instructions inputted by the user; and
displaying the function controls in the display interface of the application according to the control display instruction.

12. The method according to claim 11, wherein displaying the function controls in the display interface of the application according to the control display instruction comprises:
displaying a control window in the display interface of the application according to the control display instruction, the control window including the function controls.

13. The method according to claim 1, wherein obtaining control information stored in the load apparatus comprises:
sending a control acquisition request to the mobile platform, the control acquisition request being configured to trigger the mobile platform to obtain the control information stored in the load apparatus; and
receiving the control information sent by the mobile platform.

14. The method according to claim 1, further comprising:
receiving updated control information sent by the mobile device, the updated control information being sent to the mobile device by the load apparatus; and
updating the display interface of the application and configuring the display interface, according to the updated control information.

15. The method according to claim 1, wherein the control information comprises one of: a control name, a control identifier, a control type, and a control style.

16. The method according to claim 15, wherein the control type comprises one of the following: a switch, a button, a progress bar, a multiple-choice list, and a value input box.

17. A mobile platform, the mobile platform including a load apparatus management application for managing a load apparatus, when executed by one or more processors, the load apparatus management application implementing a load apparatus management method, comprising:
in response to an application of the load apparatus corresponding to the mobile platform being started, obtaining control information stored in the load apparatus; and
configuring a display interface of the application and displaying function controls, according to the control information, to manage the load apparatus through the function controls.

18. The mobile platform according to claim 17, the load apparatus management method further comprising:
displaying data of the load apparatus through the function controls.

19. The mobile platform according to claim 18, the mobile platform further comprising:
receiving the data of the load apparatus sent by the mobile device, the data of the load apparatus being sent to the mobile device by the load apparatus; and
displaying the data of the load apparatus in the function controls.

20. The mobile platform according to claim 19, wherein receiving the data of the load apparatus sent by the mobile device comprises:
receiving the data of the load apparatus sent by the mobile device through a wireless network.
